(19) United States
(12) Patent Application Publication
(10) Pub. No.: US 2018/0143800 A1
(43) Pub. Date: May 24, 2018

(54) CONTROLS FOR DICTATED TEXT NAVIGATION

(71) Applicant: Microsoft Technology Licensing, LLC, Redmond, WA (US)

(72) Inventor: David Lu, Seattle, WA (US)

(21) Appl. No.: 15/358,263

(22) Filed: Nov. 22, 2016

(51) Int. Cl. G06F 3/16; G06F 3/0482; G06F 3/0481; G06F 17/24

(52) U.S. Cl. CPC G06F 3/167; G06F 3/0482; G06F 3/04812; G06F 3/165; G06F 17/24; G06F 3/04817

(57) ABSTRACT

A computing device including a housing, a selection mechanism, a microphone to receive a dictated text, a display device having the dictated text displayed on the display device and an electronic processor. The electronic processor determines the computing device is in at least one of a voice-recognition state and a playback state, modify a function associated with the selection mechanism based on determining the computing device is in at least one of the voice-recognition state and the playback state, performs a first function using the selection mechanism, the first function includes moving a cursor associated with the dictated text to a new position and generating an audio output associated with the new position of the cursor, and performs a second function in response to selection of the selection mechanism when dictated text is not displayed on the display, the second function different from the first function.

### FIELD

Embodiments relate to a computing device having controls for navigating through dictated text.

### BACKGROUND

A user typically interacts with a computer running a software program or application via a user interface (for example, a graphical user interface (GUI)). The user may use a touchpad, keyboard, mouse, or other input device to enter commands, selections, and other input. However, reading, navigating, and selecting particular portions of text and other elements in a graphical user interface is not possible when a user has impaired vision or when it is impossible or impractical to view the graphical user interface (for example, the user is driving, there is glare from the sun, etc.).

### SUMMARY

Thus, while graphical user interfaces are useful, there are times when an audio interface that narrates or dictates text is beneficial. Narration-based applications have been developed as a mechanism of providing an audio interface for applications designed for user interaction via a graphical user interface. In cases where a user cannot interact with the screen of their computing device (for example, a smart phone) and wishes to compose material (for example, an email), navigating through dictated text is difficult.

Embodiments of devices, methods, and systems provided herein provide a selection mechanism to facilitate navigation of dictated text. In one example, a pre-existing selection mechanism (for example, volume or microphone controls) is re-configured (or remapped) to navigate through dictated text and to select portions of the dictated text.

Some embodiments of a device, method, and system provided herein automatically modify the volume or microphone controls to permit a user to navigate through dictated text and select the dictated text for modification or replacement.

One embodiment provides a computing device. The computing device include a housing, a selection mechanism included in the housing, a microphone to receive a dictated text, a display device having the dictated text displayed on the display device and an electronic processor. The electronic processor is configured to execute instructions to determine the computing device is in at least one of a voice-recognition state and a playback state; modify a function associated with the selection mechanism based on determining the computing device is in at least one of the voice-recognition state and the playback state; perform a first function using the selection mechanism, wherein the first function includes moving a cursor associated with the dictated text to a new position and generating an audio output associated with the new position of the cursor; and perform a second function in response to selection of the selection mechanism when dictated text is not displayed on the display, the second function different from the first function.

Another embodiment provides a method for controlling navigation through dictated text displayed in a computing device. The method includes determining, with an electronic processor, the computing device is in at least one of a voice-recognition state and a playback state. The method also includes modifying, with the electronic processor, a function associated with a selection mechanism when the computing device is in the voice-recognition state. The method also includes performing a first function using the selection mechanism, wherein the first function includes moving a cursor associated with the dictated text to a new position and generating an audio output associated with the new position of the cursor. The method includes further performing a second function different from the first in response to selection of the selection mechanism when dictated text is not displayed on the display.

A yet another embodiment provides a controller for dictated text navigation. The controller includes a selection mechanism communicatively coupled to a display and an electronic processor. The electronic processor configured to execute instructions to modify a function associated with the selection mechanism based on determining the controller is in at least one of a voice-recognition state and a playback state; perform a first function using the selection mechanism, wherein the first function includes moving a cursor associated with the dictated text to a new position and generating an audio output associated with the new position of the cursor; and perform a second function in response to selection of the selection mechanism when dictated text is not displayed on the display, the second function different from the first function.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a computing device in accordance with some embodiments.

FIG. 2 schematically illustrates a block diagram of the computing device shown in FIG. 1, in accordance with some embodiments.

FIG. 3 illustrates a software application interaction, in accordance with some embodiments.

FIG. 4 illustrates the input device shown in FIG. 1, in accordance with some embodiments.

FIG. 5 is a flow chart of a method showing a process of remapping the functionality of volume control buttons in a computing device, in accordance with some embodiments.

FIG. 6 is a flow chart of a method for controlling navigation through dictated text displayed in a computing device, in accordance with some embodiments.

FIG. 7 illustrates a visual user interface of the computing device shown in FIG. 1, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments provided herein.

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

Before any embodiments are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

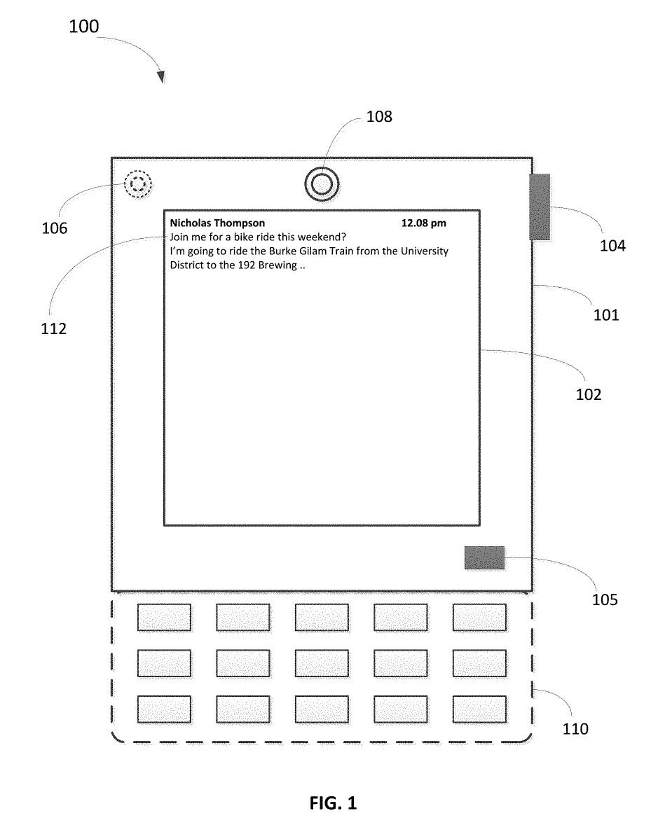

FIG. 1 illustrates a computing device 100 in accordance with some embodiments. The computing device 100 includes a housing 101, a display 102 (sometimes referred to as a display device), a touch-sensitive button 103 (for example, a device to control a microphone) an input device (for example, a button or a knob associated with either a volume control) 104, microphone 105, speaker 106, an optional camera 108, and an optional keyboard 110. The display 102 displays textual information 112 that include text information generated as a result of converting sound (containing spoken words) sensed by the microphone 105 and converted to text via a speech-to-text application.

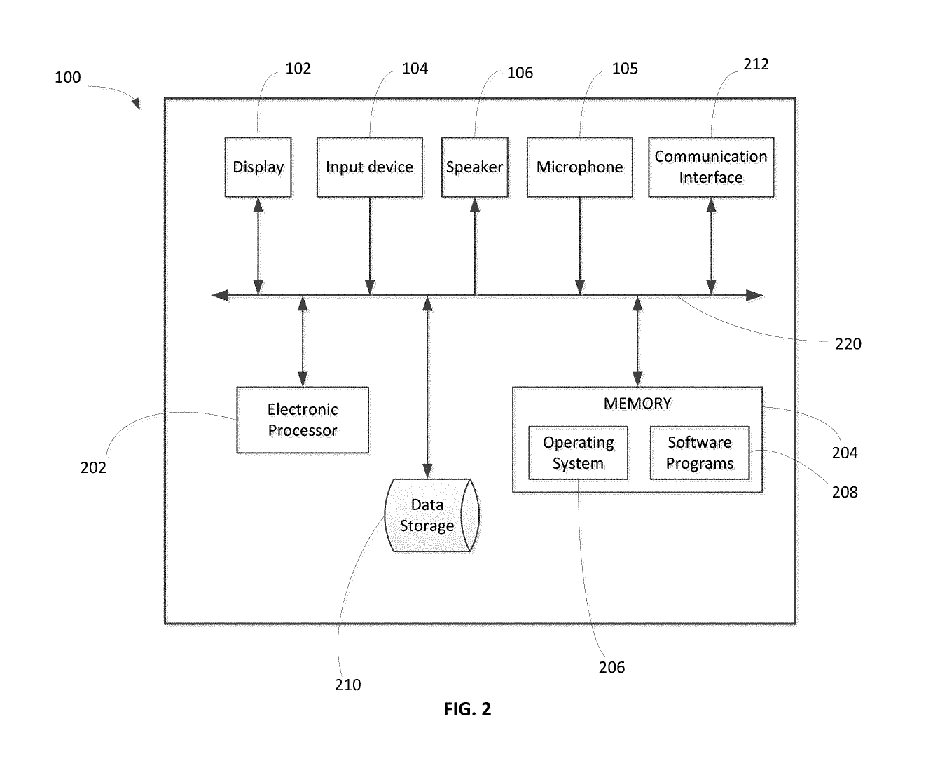

FIG. 2 illustrates a block diagram of the computing device 100 in FIG. 1 in accordance with some embodiments. The computing device 100 may combine hardware, software, firmware, and/or system on-a-chip technology to implement a narration controller. The computing device 100 may include an electronic processor 202, a memory 204, data storage 210, a display 102, the input device 104, speaker 106, microphone 105, a communication interface 212 and a bus 220. The memory 204 may include an operating system 206 and application software or programs 208. The electronic processor 202 may include at least one processor or microprocessor that interprets and executes runs the operating system and instructions that comprise the programs 208. The programs 208 may include instructions detailing a method that when executed by one or more processors, such as the electronic processor 202, cause the one or more processors to perform one or more methods described. The memory 204 may also store temporary variables or other intermediate information used during the execution of instructions by the processor 202. The memory 204 can include volatile memory elements (for example, random access memory (RAM), nonvolatile (or non-transitory) memory elements (for example, ROM), and combinations thereof. The memory 204 can have a distributed architecture, where various components are situated remotely from one another, but may be accessed by the electronic processor 202.

The data storage 210 may include a tangible, machine-readable medium storing machine-readable data and information. For example, the data storage 210 may store a database.

The bus 220 or one or more other component interconnections communicatively couples or connects the components of the computing device 100 to one another. The bus 220 may be, for example, one or more buses or other wired or wireless connections. The bus 220 may have additional elements, which are omitted for simplicity, such as controllers, buffers (for example, caches), drivers, repeaters and receivers, or other similar components, to enable communications. The bus 220 may also include address, control, data connections, or a combination of the foregoing to enable appropriate communications among the aforementioned components.

The communication interface 212 provides the computing device 100 a communication gateway with an external network (for example, a wireless network, the internet, etc.). The communication interface 212 may include, for example, an Ethernet card or adapter or a wireless local area network (WLAN) card or adapter (for example, IEEE standard 802.11a/b/g/n). The communication interface 212 may include address, control, and/or data connections to enable appropriate communications on the external network.

In one example, the electronic processor 202 is configured to execute instructions to determine maintain or change between one of two states: a voice-recognition state (for example, when a dictation is being recorded) and a playback state (for example, when a recorded dictation is being played back). In one example, the electronic processor 202 enters the voice-recognition state when the microphone 105 has been activated by a voice that is recognized by the electronic processor 202. The electronic processor 202 may transition to a playback state when audio playback has been activated. In one embodiment, audio playback may be activated using audio playback controls associated with a software program 208. The electronic processor 202 may also be configured to execute instructions to modify a function associated with the input device 104 based on a determination of whether the electronic processor 202 is in either a voice-recognition state or a playback state. In one example, when a user selects a program (for example, a dictation application) within the computing device 100 to perform dictation of textual information, the electronic processor 202 remaps (or changes) the default function (for example, volume control) associated with the input device 104 to a function that provides navigation control. In one example, the remapping of the volume control to the navigation control enables the user of the computing device 100 to navigate through the dictated text by selecting, highlighting and/or replacing portions of the dictated text. The computing device 100 may also provide an onscreen button (for example, a button shown on a touch screen display) that can be activated to begin dictation and/or replace a highlighted text.

In another example, the function of the touch-sensitive button 103 may be modified from controlling a microphone to allowing the user to navigate through dictated text using touch-sensitive button 103. Upon modification, the input device may also be used to select portions of the dictated text that needs to be modified or replaced. In one example, the electronic processor 202 is configured to execute instructions to move a cursor associated with the dictated text to a new position and generate an audio output narrating the new position of the cursor. In another example, the electronic processor 202 is configured to execute instructions to perform a volume control or microphone control function when the dictated text is not displayed on the display 102. The electronic processor 202 may be configured to receive and interpret audio instructions received using the microphone 105 to replace a selected portion of the dictated text with a newly dictated text.

In one example, the input device 104 is configured to select a portion of the dictated text and replace the dictated text with a new text received using the microphone 105. The input device 104 may select a particular portion of the dictated text by navigating a cursor in either a forward or a backward direction to reach the particular portion of the dictated text. In one embodiment, the input device 104 may be operated by an external device (for example, volume controls in a pair of headphones) that is communicatively coupled (using Bluetooth connectivity) to the computing device 100. In one example, when the input device 104 is controlled using a Bluetooth enabled headphones, the Volume Up button is pressed to highlight the next word in relation to the position of a cursor. Similarly, the Volume Down button may be pressed to highlight the previous word in relation to the position of the cursor.

The various buttons (for example touch-sensitive button 103 and/or volume control button 402) associated with the computing device 100 may remapped as follows:
Volume Up button is remapped to “UP”
Volume Down button is remapped to “DOWN”
Toggle Play/Pause button (typically existing on headphone remotes) is remapped to SELECT

The various buttons associated with the computing device 100 may be remapped as follows:
Volume Up button is remapped to Highlight Previous Word
Volume Down button is remapped to Highlight Next Word
Toggle Play/Pause button is remapped to Begin Dictating (and replace highlighted text)

The range of highlighting actions may include the following:
Highlight nothing, place cursor at the beginning of the document
Highlight all text
Highlight 1^{st} word
Highlight 2^{nd} word
Highlight (n−1)th word
Highlight nth word
Highlight all text
Highlight nothing, place cursor at the end of the document.

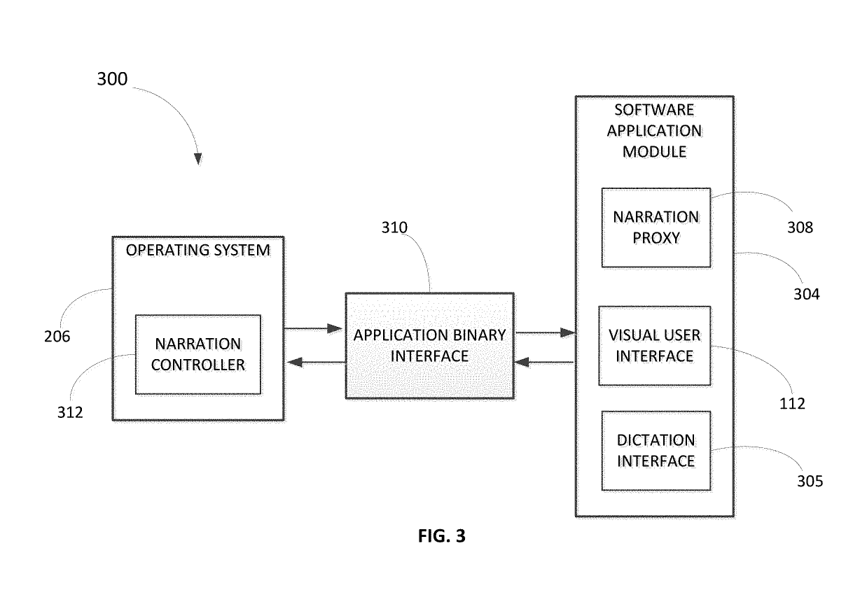

FIG. 3 illustrates an interaction 300 of software applications, in accordance with some embodiments. The computing device executes the operating system 206, which manages a software application module 304. The software application module 304 is a software application, or portion of a software application. The application module 304 includes a visual user interface 112, a narration proxy 308, and a dictation interface 305. The dictation interface 305 may be used to recognize and present the dictated text on the display 102 using visual user interface 112. In some embodiments, the narration proxy 308 may be configured to receive textual data presented by the visual user interface 112 and provide implicit narration associated with the received textual data. In one embodiment, the application module 304 communicates with the operating system 206 via an application binary interface (ABI) 310. The application binary interface 310 is a tool allowing the application module 304 to access specific tools, functions, and/or calls provided by the operating system 206. One of the tools provided by the operating system 206 may be a narration controller 312, which converts text received from the application module 304 to an audio format to be played using the speaker 106 for a user. In one example, the visual user interface 112 is configured to receive inputs from a user via an input device 104 to select portions of dictated text that requires editing or replacement.

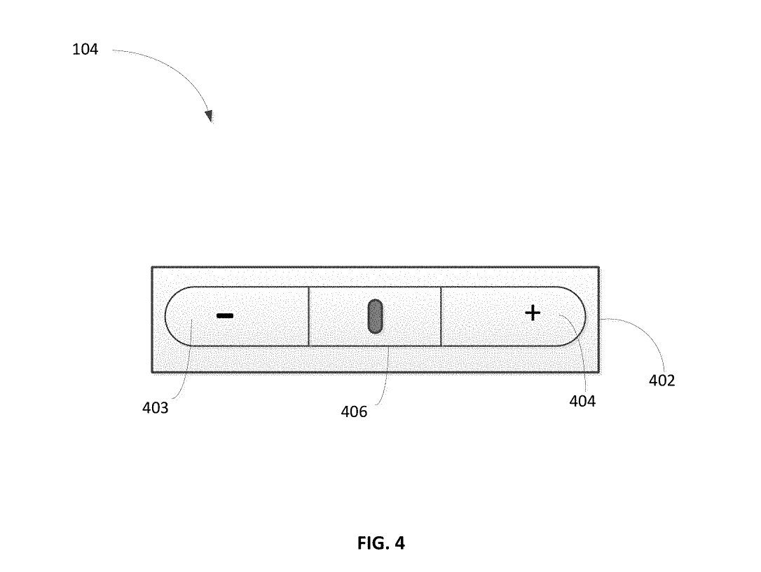

FIG. 4 illustrates the input device 104 shown in FIG. 1, in accordance with some embodiments. In some embodiments, the input device 104 includes a volume control button 402 that includes a first portion 403 (denoted by “_” that corresponds to “DOWN”) and a second portion 404 (denoted by “+” that corresponds to “UP”). The first portion 403 may be used to engage a switch (not shown) that completes an electrical circuit to provide a signal to the electronic processor 202, which in turn controls an audio amplifier circuit to decrease the volume of the implicit audio narration at speaker 106. Similarly, second portion 404 may be used to increase the volume of the implicit audio narration at speaker 106. In one example, the input device 104 includes a button 406 associated with controlling the microphone 406. The button 406 may be used to select dictated text.

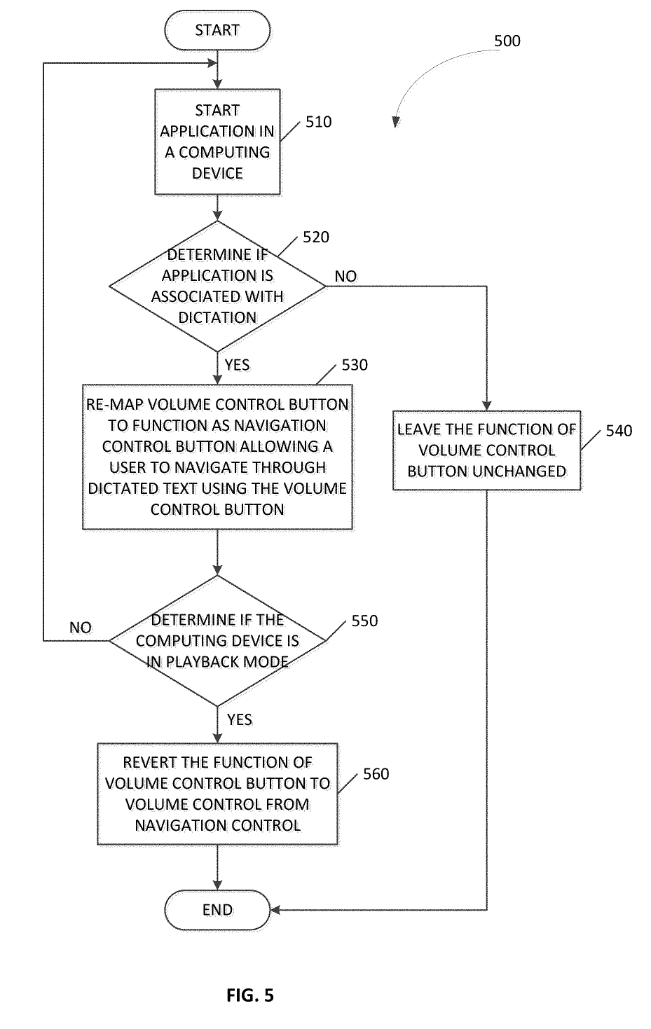

FIG. 5 is a flow chart of a method 500 showing the process of remapping the functionality of volume control buttons in a computing device, in accordance with some embodiments. At block 510, an application is activated or executed in the computing device 100. At decision block 520, the operating system 206 determines whether the application is associated with a dictation operation. When the operating system 206 determines that the opened application is not associated with a dictation operation, the method 500 proceeds to block 540. When the operating system 206 determines that the opened application is associated with a dictation operation, the method 500 proceeds to block 530. At block 530, the method 500 re-maps or reconfigures the volume control button 402 to function as a navigation control button allowing a user to navigate through dictated text using the volume control button 402. At block 540, the method 500 leaves the function of the volume control button (for example, button 402) unchanged. After block 530, the method 500 proceeds to block 550. At block 550, the operating system 206 determines whether the computing device is in a playback mode or status. When the computing device is in a playback mode, the method 500 proceeds to block 560. At block 560, the method 500 reverts the function of the volume control button 402 to volume control from navigation control. When the computing device is determined to not be in the playback mode, the method 500 goes back to start of the process at block 510.

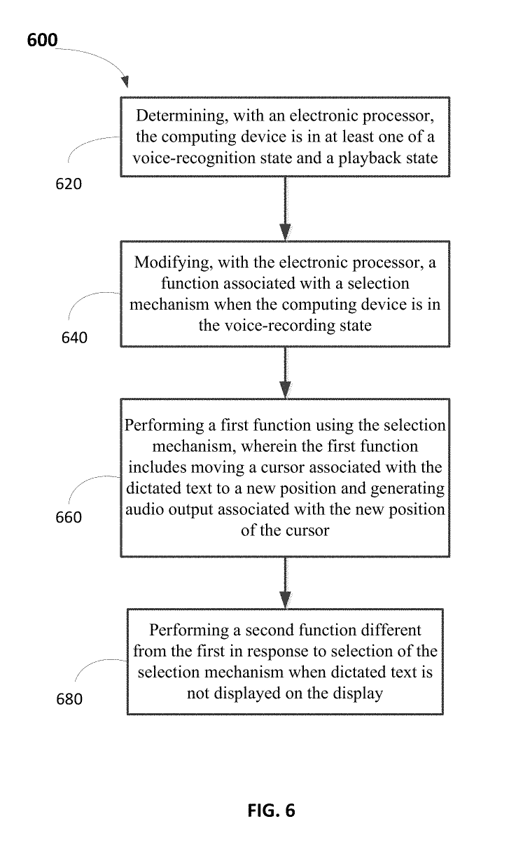

FIG. 6 is a flow chart of a method 600 for controlling navigation through dictated text displayed in the computing device 100, in accordance with some embodiments.

At block 620, the method 600 includes determining with the electronic processor 202 that the computing device 100 and, more particularly, whether the electronic processor 202 is in at least one of a voice-recognition state and a playback state. In the voice-recognition state, the computing device 100 is configured to receive dictated text and present the dictated text to the visual user interface 112 to be displayed on the display 102.

At block 640, the method 600 includes modifying with the electronic processor 202, a function associated with a selection mechanism (for example, input device 104) when the computing device 100 is in the voice-recognition state.

At block 660, the method 600 includes performing a first function using the selection mechanism. The first function includes moving a cursor associated with the dictated text to a new position of the cursor and generating an audio output associated with the new position of the cursor. In one example, the first function includes replacing a selected portion of the dictated text with a newly dictated text at the new position of the cursor. The first function may also include replacing a word at the new position of the cursor with a new word received using the microphone 105.

At block 680, the method 600 includes performing a second function different from the first in response to selection of the input device 104 when dictated text is not displayed on the display 102 of computing device 100. In one example, the second function includes controlling the volume of the audio output using the input device 104.

In one example, the method 600 includes receiving instructions using the microphone 105 to replace the selected portion of the dictated text with the newly dictated text. In another embodiment, the method 600 includes navigating the cursor in at least one of a forward direction and a backward direction to select a portion of the dictated text using the input device 104.

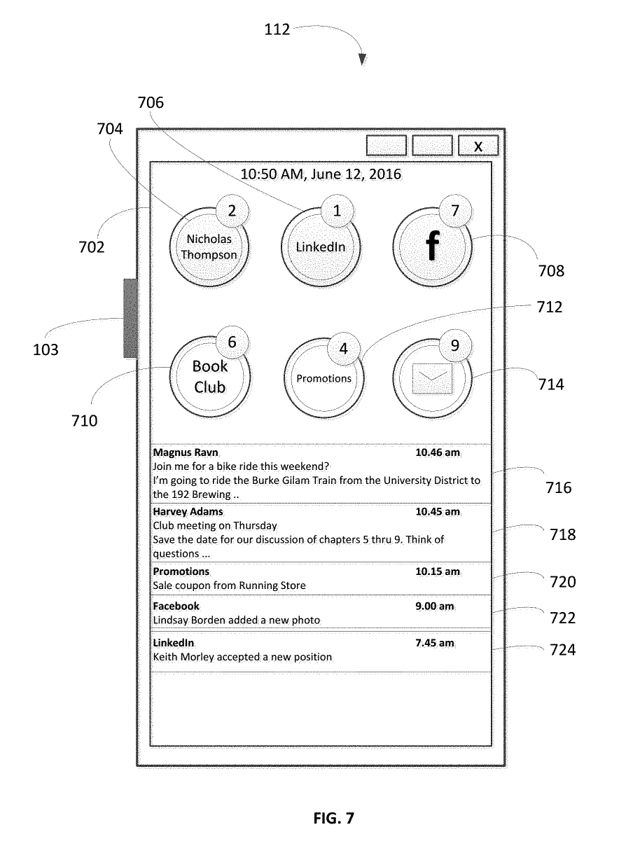

FIG. 7 illustrates a visual user interface 112, in accordance with some embodiments. In one example, the visual user interface 112 is a graphical user interface (GUI). The visual user interface 112 includes a visual frame 702. In one example, the visual frame 702 is a window. The visual frame 702 includes one or more items 704, 706, 708, 710, 712, 714, 716, 718, 720, 722, and 724. The items 704, 706, 708, 710, 712, and 714 are icons that may include both textual and graphical information to the user. For example, the item 704 may be associated with a message box of a user, which in the example illustrated is “Nicholas Thompson.” The item 704 may also show a count of the number of unread messages (in this case, “2”) that the user has received. In the example provides, the item 706 is associated with messages from a software application, “LinkedIn.” The item 706 also includes a count of the number of unread messages (in this case, “1”) that the user has received from “LinkedIn.” The item 708 is associated with messages from a software application, namely “Facebook” and includes a count of the number of unread messages (in this case, “7”) that the user has received from the “Facebook” application. The item 710 is associated with messages from an application namely “Book Club” and includes a count of the number of unread messages (in this case, “6”) that the user has received from the “Book Club” application. The item 712 is associated with an application namely “Promotions” and includes a count of the number of unread messages (in this case, “4”) that the user has received from the “Promotions” application. The user interface item 714 is associated with messages from an email system. The user interface item 714 also includes a count of the number of unread emails (in this case, “9”) that the user has received.

In some embodiments, the narration controller 312 vocalizes the graphical and textual information associated with items 704, 706, 708, 710, 712, 714, 716, 718, 720, 722, and 724 in response to an input command (for example, using input 104) received from a user. In one example, the input command includes an audio command that may be received using the microphone 105.

One example of the outputting implicit audio narration is provided below.

### Example A

Timestamp: Friday, October 28^{th}, 2016

Sender: Frank, <frank@example.com>

Receiver: you, Carol Smith <carol@example.com>, Jim <jim@example.com>, Arnold <Arnold@example.com>, Bob <bob@example.com>

Subject: Meet for lunch today?

Message body: Hey all, who is interested in going out to lunch today?

The narration information generated from the various fields associated with the email shown above in Example A are as follows:

Time: On Friday (assuming the time stamp is within the last 7 days)

Sender: Frank

Verb: asked

Direct object: none

Subject: “Meet for lunch today”

The implicit audio narration information that may be generated for the above email is given below:

On Friday, Frank asked, “Meet for lunch today?”

In one example, the input device 104 may be used to move a cursor within the implicit narration information “On Friday, Frank asked, “Meet for lunch Today?” to select a portion of the implicit narration information for replay.

In some embodiments, software described herein may be executed by a server, and a user may access and interact with the software application using a portable communication device. Also, in some embodiments, functionality provided by the software application as described above may be distributed between a software application executed by a user's portable communication device and a software application executed by another electronic process or device (for example, a server) external to the portable communication device. For example, a user can execute a software application (for example, a mobile application) installed on his or her smart device, which may be configured to communicate with another software application installed on a server.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. A device or structure that is “configured” in a certain way is configured in at least that way, but may also be configured in ways that are not listed.

We claim:

1. A computing device comprising:
a housing;
a selection mechanism included in the housing;
a microphone to receive a dictated text;
a display device having the dictated text displayed on the display device; and
an electronic processor configured to execute instructions to
determine the computing device is in at least one of a voice-recognition state and a playback state;
modify a function associated with the selection mechanism based on determining the computing device is in at least one of the voice-recognition state and the playback state;
perform a first function using the selection mechanism, wherein the first function includes moving a cursor associated with the dictated text to a new position and generating an audio output associated with the new position of the cursor; and
perform a second function in response to selection of the selection mechanism when dictated text is not displayed on the display, the second function different from the first function.

2. The computing device of claim 1, wherein the selection mechanism is configured to select a portion of the dictated text and replace the dictated text with a new text received using the microphone.

3. The computing device of claim 1, wherein the selection mechanism includes a volume control button.

4. The computing device of claim 3, wherein the second function includes controlling the volume of the audio output using the volume control button.

5. The computing device of claim 3, wherein the volume control button is configured to navigate the cursor in a forward direction and a backward direction and select a portion of the dictated text.

6. The computing device of claim 1, wherein the electronic processor is further configured to execute instructions to
receive instructions using the microphone to replace a selected portion of the dictated text with a newly dictated text.

7. The computing device of claim 1, wherein the electronic processor is further configured to execute instructions to
replace a first dictated word at the new position with a second dictated word.

8. A method for controlling navigation through dictated text displayed in a computing device, the method comprising:
determining, with an electronic processor, the computing device is in at least one of a voice-recognition state and a playback state;
modifying, with the electronic processor, a function associated with a selection mechanism when the computing device is in the voice-recognition state;
performing a first function using the selection mechanism, wherein the first function includes moving a cursor associated with the dictated text to a new position and generating an audio output associated with the new position of the cursor; and
performing a second function different from the first in response to selection of the selection mechanism when dictated text is not displayed on the display.

9. The method of claim 8, wherein the first function includes replacing a selected portion of the dictated text with a newly dictated text at the new position of the cursor.

10. The method of claim 8, wherein the first function includes replacing a word at the new position with a new word received using a microphone.

11. The method of claim 8, wherein the second function includes controlling the volume of the audio output using the selection mechanism.

12. The method of claim 9, further comprising:
receiving instructions using a microphone to replace the selected portion of the dictated text with the newly dictated text.

13. The method of claim 8, further comprising:
navigating the cursor in at least one of a forward direction and a backward direction to select a portion of the dictated text using the selection mechanism.

14. A controller for dictated text navigation, the controller comprising:
a selection mechanism communicatively coupled to a display and an electronic processor, the electronic processor configured to execute instructions to
modify a function associated with the selection mechanism based on determining the controller is in at least one of a voice-recognition state and a playback state;
perform a first function using the selection mechanism, wherein the first function includes moving a cursor associated with the dictated text to a new position and generating an audio output associated with the new position of the cursor; and
perform a second function in response to selection of the selection mechanism when dictated text is not displayed on the display, the second function different from the first function.

15. The controller of claim 14, wherein the selection mechanism includes a volume control button.

16. The controller of claim 14, wherein the selection mechanism is configured to select a portion of the dictated text and replace the dictated text with a new text using a microphone.

17. The controller of claim 15, wherein the second function includes controlling the volume of the audio output using the volume control button.

18. The controller of claim 14, wherein the electronic processor is configured to receive instructions using a microphone to replace the selected portion of the dictated text with the newly dictated text.

19. The controller of claim 14, wherein the electronic processor is further configured to execute instructions to
replace a first dictated word with a second dictated word at the new position of the cursor.

20. The controller of claim 14, wherein the selection mechanism is configured to navigate the cursor in at least one of a forward direction and a backward direction and select a portion of the dictated text.
